(19) United States
(12) Patent Application Publication
(10) Pub. No.: US 2026/0362389 A1
(43) Pub. Date: Nov. 12, 2026

(54) METHOD FOR TRAINING POSITIONING MODEL, TERMINAL DEVICE, AND NETWORK DEVICE

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/723,270

(22) Filed: Jun. 29, 2026

Related U.S. Application Data
(63) Continuation of application No. PCT/CN2024/073498, filed on Jan. 22, 2024.

(51) Int. Cl. H04W 64/00

(52) U.S. Cl. CPC H04W 64/006

(57) ABSTRACT

A method for training a positioning model includes: transmitting, by a terminal device, first data to a network device. The first data is used to determine second data, the first data and the second data are used as training data for a positioning model, and the positioning model is use to locate the terminal device in a target positioning area. The target positioning area includes a first grid cell, and the first data are measurement results of a reference signal that are obtained by the terminal device when the terminal device is located in the first grid cell.

### CROSS REFERENCE TO RELATED APPLICATIONS

The present application is a continuation of International Application No. PCT/CN2024/073498, filed on Jan. 22, 2024, which is incorporated by reference herein in its entirety.

### TECHNICAL FIELD

The application relates to the field of communication technology, and more particularly, to a method for training a positioning model, a terminal device, and a network device.

### BACKGROUND

Fingerprint database positioning technology is a commonly used method for indoor positioning. In order to achieve higher positioning accuracy, fingerprint database positioning technology usually requires the collection of extensive fingerprint data to build a fingerprint database. However, the collection of such extensive fingerprint data is time-consuming and costly.

### SUMMARY

Embodiments of the present disclosure provide a method for training a positioning model, a terminal device, and a network device. Various aspects of the present disclosure are described in detail below.

In a first aspect, there is provided a method for training a positioning model, including: transmitting, by a terminal device, first data to a network device, where the first data is used to determine second data, the first data and the second data are used as training data for a positioning model, and the positioning model is used to locate the terminal device in a target positioning area, and the target positioning area includes a first grid cell, and the first data are measurement results of a reference signal that are obtained by the terminal device when the terminal device is located in the first grid cell.

In some embodiments, the second data is obtained by performing random sampling within a distribution range of the first data, and/or the second data is obtained by performing sampling, in accordance with probability values, within the distribution range of the first data.

In some embodiments, distribution characteristics of the first data are determined based on distribution characteristics of third data, the third data are measurement results of a reference signal in a reference area, and the reference area is of a same type as the target positioning area.

In some embodiments, an amount of the first data is determined based on the distribution characteristics of the third data.

In some embodiments, part or all of the second data include position tags.

In some embodiments, the position tags corresponding to the second data are position coordinates that are randomly generated within the first grid cell.

In some embodiments, output results of the positioning model include position coordinates and position information of the first grid cell, or output results of the positioning model include position information of the first grid cell.

In some embodiments, distribution characteristics of the first data include its conformity to a Gaussian distribution, and an expression of a joint Gaussian distribution of the first grid cell is determined based on a mean matrix and a standard deviation matrix.

In a second aspect, there is provided a method for training a positioning model, including: receiving, by a network device, first data transmitted by a terminal device, where the first data is used to determine second data, the first data and the second data are used as training data for a positioning model, and the positioning model is used to locate the terminal device in a target positioning area, and the target positioning area includes a first grid cell, and the first data are measurement results of a reference signal that are obtained by the terminal device when the terminal device is located in the first grid cell.

In some embodiments, the second data is obtained by performing random sampling within a distribution range of the first data, and/or the second data is obtained by performing sampling, in accordance with probability values, within the distribution range of the first data.

In some embodiments, distribution characteristics of the first data are determined based on distribution characteristics of third data, the third data are measurement results of a reference signal in a reference area, and the reference area is of a same type as the target positioning area.

In some embodiments, an amount of the first data is determined based on the distribution characteristics of the third data.

In some embodiments, part or all of the second data include position tags.

In some embodiments, the position tags corresponding to the second data are position coordinates that are randomly generated within the first grid cell.

In some embodiments, output results of the positioning model include position coordinates and position information of the first grid cell, or output results of the positioning model include position information of the first grid cell.

In some embodiments, distribution characteristics of the first data include its conformity to a Gaussian distribution, and an expression of a joint Gaussian distribution of the first grid cell is determined based on a mean matrix and a standard deviation matrix.

In a third aspect, there is provided a terminal device, including: a transmitting unit, transmitting first data to a network device, where the first data is used to determine second data, the first data and the second data are used as training data for a positioning model, and the positioning model is used to locate the terminal device in a target positioning area, and the target positioning area includes a first grid cell, and the first data are measurement results of a reference signal that are obtained by the terminal device when the terminal device is located in the first grid cell.

In some embodiments, the second data is obtained by performing random sampling within a distribution range of the first data, and/or the second data is obtained by performing sampling, in accordance with probability values, within the distribution range of the first data.

In some embodiments, distribution characteristics of the first data are determined based on distribution characteristics of third data, the third data are measurement results of a reference signal in a reference area, and the reference area is of a same type as the target positioning area.

In some embodiments, an amount of the first data is determined based on the distribution characteristics of the third data.

In some embodiments, part or all of the second data include position tags.

In some embodiments, the position tags corresponding to the second data are position coordinates that are randomly generated within the first grid cell.

In some embodiments, output results of the positioning model include position coordinates and position information of the first grid cell, or output results of the positioning model include position information of the first grid cell.

In some embodiments, distribution characteristics of the first data include its conformity to a Gaussian distribution, and an expression of a joint Gaussian distribution of the first grid cell is determined based on a mean matrix and a standard deviation matrix.

In a fourth aspect, there is provided a network device, including: a receiving unit, receiving first data transmitted by a terminal device, where the first data is used to determine second data, the first data and the second data are used as training data for a positioning model, and the positioning model is used to locate the terminal device in a target positioning area, and the target positioning area includes a first grid cell, and the first data are measurement results of a reference signal that are obtained by the terminal device when the terminal device is located in the first grid cell.

In some embodiments, the second data is obtained by performing random sampling within a distribution range of the first data, and/or the second data is obtained by performing sampling, in accordance with probability values, within the distribution range of the first data.

In some embodiments, distribution characteristics of the first data are determined based on distribution characteristics of third data, the third data are measurement results of a reference signal in a reference area, and the reference area is of a same type as the target positioning area.

In some embodiments, an amount of the first data is determined based on the distribution characteristics of the third data.

In some embodiments, part or all of the second data include position tags.

In some embodiments, the position tags corresponding to the second data are position coordinates that are randomly generated within the first grid cell.

In some embodiments, output results of the positioning model include position coordinates and position information of the first grid cell, or output results of the positioning model include position information of the first grid cell.

In some embodiments, distribution characteristics of the first data include the first data's conformity to a Gaussian distribution, and an expression of a joint Gaussian distribution of the first grid cell is determined based on a mean matrix and a standard deviation matrix.

In a fifth aspect, there is provided a terminal device, including a processor and a memory storing one or more computer programs, where the processor is configured to call the computer programs in the memory to cause the terminal device to perform a part or all of the steps in the method of the first aspect.

In a sixth aspect, there is provided a network device, including: a processor, a memory, and a transceiver, where the memory is configured to store one or more programs, and the processor is configured to call the computer programs in the memory to cause the network device to perform a part or all of the steps in the method of the second aspect.

In a seventh aspect, there is provide a communication system including the terminal device and/or network device as described above. In an alternative design, the system may further include another device that interacts with the terminal device or the network device in the solutions according to embodiments of the disclosure.

In an eighth aspect, there is provided a computer-readable storage medium storing a computer program, where the computer program is configured to cause the terminal device and/or the network device to perform a part or all of the steps in the methods described in the foregoing aspects.

In a ninth aspect, there is provided a computer program product, where the computer program product includes a non-transitory computer-readable storage medium storing a computer program, and the computer program is operable to cause the terminal device and/or the network device to perform a part or all of the steps in the methods described in the foregoing aspects. In some implementations, the computer program product may be a software installation package.

In a tenth aspect, there is provided a chip including a memory and a processor, where the processor is configured to call and run a computer program from the memory to perform a part or all of the steps in the methods described in the foregoing aspects.

Through research, the applicant has discovered that the fingerprint data in a given region exhibits a certain degree of correlation, that is, many of the collected fingerprint data are actually similar or redundant. Therefore, dense data collection may not be necessary. Based on this, a method according to embodiments of the present disclosure may acquire, based on actually collected fingerprint data (that is, first data), some expanded fingerprint data (that is, second data), and use both the first data and the second data for training a positioning model. In such a way, the amount of the fingerprint data that needs to be collected during the establishment of a fingerprint database may be reduced, thereby helping to reduce the time and resource consumption of establishing the fingerprint database.

### BRIEF DESCRIPTION OF THE DRAWINGS

FIG. 1 is a schematic diagram of a wireless communication system to which embodiments of the present disclosure are applied.

FIG. 2 is an example diagram of a line-of-sight scenario and a non-line-of-sight scenario.

FIG. 3 is a schematic diagram illustrating fingerprint data locations in an indoor factory-dense high scenario.

FIG. 4 is a schematic diagram illustrating a Gaussian distribution curve of fingerprint data of a grid cell in FIG. 3.

FIG. 5 is a schematic diagram illustrating dispersion of fingerprint data of a grid cell in FIG. 3.

FIG. 6 is a schematic flowchart illustrating a method for training a positioning model according to some embodiments of the present disclosure.

FIG. 7A is an example diagram of obtaining augmented fingerprint data according to some embodiments of the present disclosure.

FIG. 7B is an example diagram of training a positioning model according to some embodiments of the present disclosure.

FIG. 7C is a flowchart illustrating a method for using a positioning model according to some embodiments of the present disclosure.

FIG. 8 is a schematic structural diagram of a terminal device according to some embodiments of the present disclosure.

FIG. 9 is a schematic structural diagram of a network device according to some embodiments of the present disclosure.

FIG. 10 is a schematic structural diagram of an apparatus according to some embodiments of the present disclosure.

### DETAILED DESCRIPTION OF THE EMBODIMENTS

The technical solutions in the present disclosure will be described below in conjunction with the accompanying drawings.

### Communication System

FIG. 1 illustrates a wireless communication system 100 to which embodiments of the present disclosure are applied. The wireless communication system 100 may include a network device 110 and terminal devices 120. The network device 110 may be a device that communicates with the terminal devices 120. The network device 110 may provide communication coverage for a specific geographic area, and may communicate with the terminal devices 120 located in a coverage area.

FIG. 1 exemplarily illustrates one network device and two terminal devices. Optionally, the wireless communication system 100 may include a plurality of network devices, and another quantity of terminal devices may be present in the coverage area of each network device, which is not limited in the embodiments of the present disclosure.

Optionally, the wireless communication system 100 may further include other network entities such as a network controller, and a mobile management entity, which is not limited in the embodiments of the present disclosure.

It should be understood that the technical solutions provided in the embodiments of the present disclosure may be applied to various communication systems, such as a 5^{th} generation (5G) system or new radio (NR) system, a long term evolution (LTE) system, an LTE frequency division duplex (FDD) system, and an LTE time division duplex (TDD) system. The technical solutions provided in the embodiments of the present disclosure may also be applied to future communication systems, such as a 6^{th} generation mobile communication system, and a satellite communication system.

The terminal device in the embodiments of the present disclosure may also be referred to as a user equipment (UE), an access terminal, a subscriber unit, a subscriber station, a mobile station (MS), a mobile terminal (MT), a remote station, a remote terminal, a mobile device, a user terminal, a wireless communication device, an user agent, or a user apparatus. The terminal device in the embodiments of the present disclosure may be a device that provides voice and/or data connectivity to a user, and may be used to connect people, objects, and machines, such as a handheld device and an in-vehicle device having a wireless connection function. The terminal device in the embodiments of the present disclosure may be a mobile phone, a tablet computer (Pad), a notebook computer, a palmtop, a mobile internet device (MID), a wearable device, a virtual reality (VR) device, an augmented reality (AR) device, a wireless terminal used in industrial control, a wireless terminal in self-driving, a wireless terminal used in remote medical surgery, a wireless terminal used in smart grid, a wireless terminal used in transportation safety, a wireless terminal in smart city, and a wireless terminal in smart home. Optionally, the UE may be configured to serve as a base station. For example, the UE may serve as a scheduling entity that provides sidelink signals between UEs in vehicle-to-everything (V2X) or device-to-device (D2D). For example, a cellular phone and a vehicle may communicate with each other using the sidelink signals. A cellular phone and a smart home device communicate directly without relaying communication signals through a base station.

The network device in the embodiments of the present disclosure may be a device configured to communicate with the terminal device. The network device may also include an access network device. The access network device may also be referred to as a radio access network device or a base station. The access network device in the embodiments of the present disclosure may refer to a radio access network (RAN) node (or device) that connects the terminal device to the wireless network. The access network device may broadly cover or be replaced with any of the following: a node B (NodeB), a evolved NodeB (eNB), a next generation NodeB (gNB), a relay station, a access point, a transmitting and receiving point (TRP), a transmitting point (TP), a master eNB (MeNB), a secondary eNB (SeNB), a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node or the like, or a combination thereof. Alternatively, the base station may refer to a communication module, a modem, or a chip disposed in the aforementioned device or apparatus. The base station may also be a mobile switching center, or a device that perform base station functions in D2D, V2X, machine-to-machine (M2M) communication, a network-side device in 6G networks, or a device that performs base station functions in future communication systems, and the like. The base station may support networks with the same or different access technologies. The embodiments of the present disclosure place no limitation on the specific technology or specific form adopted by the access network device.

The base station may be fixed or mobile. For example, a helicopter or an unmanned aerial vehicle may be configured to serve as a mobile base station, and one or more cells may move according to a location of the mobile base station. In other examples, a helicopter or an unmanned aerial vehicle may be configured to operate as a device that communicates with another base station.

In some deployments, the network device in the embodiments of the present disclosure may refer to a CU or a DU, or the network device includes a CU and a DU. The gNB may further include an AAU.

The network device and the terminal device may be deployed on land, including indoors or outdoors, handheld or in-vehicle form; they may also be deployed on a surface of water; and they may also be deployed on an aircraft, a balloon, and a satellite in the air. The embodiments of the present disclosure impose no limitations on the deployment scenarios of the network device and the terminal device.

The communication equipment involved in a wireless communication system may include not only the access network device and the terminal device, but also a core network device. The core network device may also be a type of network device.

The core network device in the embodiments of the present disclosure may include a device configured to process and forward signaling and data of the user. For example, the core network device may include a core access and mobility management function (AMF), a session management function (SMF), a user plane gateway, a location server, and other core network devices. The user plane gateway may be a server that provides functions such as mobility management, routing, and forwarding of user plane data, and is generally located on a network side, such as a serving gateway (SGW), a packet data network gateway (PGW), a user plane function (UPF), or the like. The AMF and SMF may be equivalent to the mobility management entity (MME) in an LTE system. The AMF is primarily responsible for access aspect, and the SMF is mainly responsible for session management. Of course, the core network may also include other network elements, which are not exhaustively listed herein.

The location server has a location function. The location server involved in the embodiments of the present disclosure may include a location management function (LMF), a location management component (LMC), or a local location management function (LLMF) located in the network device, which is not limited in the embodiments of the present disclosure. In some embodiments, the location server may also be referred to as a location management device.

It should be understood that all or part of the functions of the communication devices in the present disclosure may be implemented by software functions running on hardware, or by virtualization functions instantiated on a platform (such as a cloud platform).

### Positioning Technology

With continuous progress in science and technology, various fields are presenting a trend of vigorous development. At the same time, people's demand for position-based services continues to rise. As a result, high-precision positioning methods have become one of the research hotspots at present. In a wireless positioning system, the position of a mobile terminal device may be estimated by mapping a signal characteristic to a spatial position. The positioning method may be based on one or more of the following manners: ranging, angle, proximity, and fingerprinting.

For ranging-based positioning, geometric shapes (such as circles or hyperbolas) may be constructed based on the distances from the terminal device to at least three network devices. Further, positioning results may be obtained by calculating an intersection point of the geometric shapes. Time of arrival (TOA) and time difference of arrival (TDOA) are commonly used signal characteristics in ranging-based positioning methods. The ranging-based positioning method using received signal strength (RSS) needs to fit a path loss model.

For angle-based positioning, a location of the terminal device may be estimated by calculating the angles of arrival (AOA) of at least two incoming signals.

For proximity-based positioning, a coverage area of the network device from which the terminal device receives the strongest RSS may be determined as a location of the terminal device. The coverage area of the network device is usually large, and thus the method is simple but has low positioning accuracy.

A fingerprint-based positioning method, also known as fingerprint database positioning technology, is a commonly used method for indoor positioning. The method may determine an indoor position based on fingerprint features of wireless signals. The fingerprint database positioning technology usually requires collecting positioning data (such as wireless signal data and reference point position data) at various reference points to establish a fingerprint database. The accuracy of the positioning data (also referred to as fingerprint data) of each reference point included in the fingerprint database largely depends on the sufficiency of datasets. In some embodiments, the fingerprint data may be inputted into a neural network for training to obtain a positioning model. The positioning model may be used for positioning in a target positioning area.

The establishment of fingerprint database is described in detail below.

### 1. Determine Collection Points

First, it is necessary to determine locations of the collection points in an indoor area (that is, a target positioning area). For example, the collection points may be arranged to cover the entire target positioning area, thereby ensuring the integrity of the fingerprint data. For another example, the collection points may be representative, that is, the collection points may be arranged to cover different types of environments in the target positioning area, such as different building structures and obstacle distributions in the target positioning area. In some cases, the arrangement of the collection points also needs to consider the usage of the device to be located.

Second, a number of collection points in the target positioning area may be determined based on a specific usage scenario. The quantity of fingerprint data is closely related to the positioning accuracy of the fingerprint database positioning technology. Therefore, the number of collection points may be determined based on the requirement for positioning accuracy. For example, when high positioning accuracy is desired, more collection points may be set; when lower positioning accuracy is acceptable, fewer collection points may be set.

### 2. Collect Fingerprint Data

Data is collected at the determined collection points. For example, at a given collection point, characteristics of wireless signals such as measurement results of the wireless signals, and position information of the collection point may be recorded, where the measurement results of the wireless signals and the position information of the collection point together constitute one set of fingerprint data.

In some embodiments, the fingerprint data collection may be performed in conjunction with a use state of a target positioning device. For example, a user may use the target positioning device for positioning while walking or standing, that is, the target positioning device may be in a stationary state or in a moving state. For another example, the user may use the target positioning device for positioning while moving along a predetermined path, for example, the user may use the target positioning device for positioning when on a staircase. Based on this, by way of simulating standing, walking, or walking along the predetermined path, data collection may be carried out at the determined collection points to record the characteristics of wireless signals and the corresponding position information.

### 3. Process and Store Data

In order to improve the reliability of fingerprint data, the fingerprint data may be preprocessed before storing them. For example, raw fingerprint data may be filtered and/or corrected to remove outliers or unstable data in the raw fingerprint data. The preprocessed fingerprint data may then be stored in a data format supported by the fingerprint database, such as a database, a file, or other data structures.

### 4. Update and Maintain Data

In order to adapt to changes in the indoor environment, it is usually necessary to update and maintain the fingerprint database at regular intervals, such as introducing new collection points, deleting invalid or outdated data, and updating the signal characteristics of existing data.

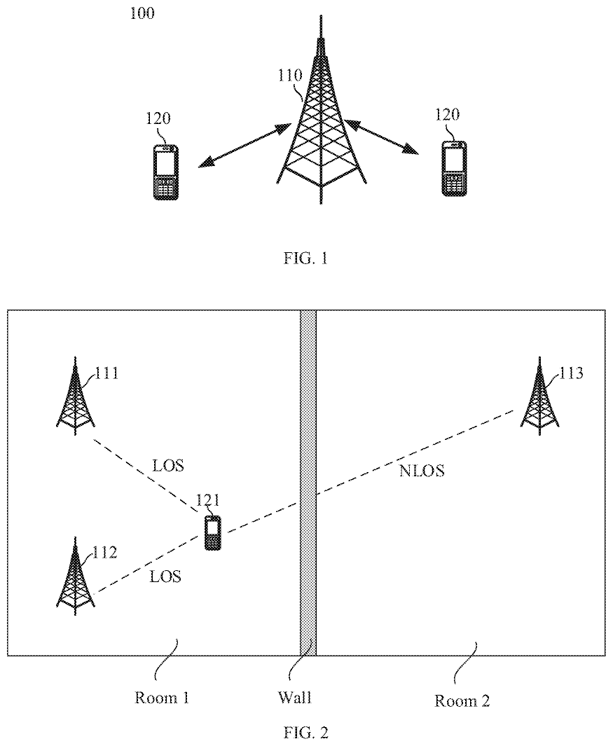

The environmental types of the target positioning area mentioned above may include, for example, a line-of-sight type. The line-of-sight type may be divided into a non-line of sight (NLOS) and a line of sight (LOS). The LOS may refer to a situation that a terminal device to be located and a first communication device are capable of observing each other either directly by sight or using a visual aid tool. The NLOS may refer to a situation that the terminal device to be located and the first communication device are incapable of observing each other by sight or using a visual aid tool. FIG. 2 is an example diagram of a line-of-sight scenario and a non-line-of-sight scenario. As shown in FIG. 2, a terminal device 121 is the terminal device to be located. The terminal device 121 is located in Room 1. A network device 111 and a network device 112 are also located in Room 1. Since they are located in the same room, and the network device 111 or the network device 112, and the terminal device 121 are capable of observing each other by sight, a line-of-sight type between the network device 111 and the terminal device 121 may be LOS, and a line-of-sight type between the network device 112 and the terminal device 121 may also be LOS. A network device 113 is located in Room 2. Since Room 1 and Room 2 are separated by a wall, it is difficult for the network device 113 and the terminal device 121 to observe each other by sight. Therefore, a line-of-sight type between the network device 113 and the terminal device 121 may be NLOS.

As can be seen from the establishment process of the above fingerprint database, with respect to the fingerprint database positioning technology for indoor positioning, the process of establishing a fingerprint database for a target positioning area is time-consuming and resource-consuming. In particular, for large-scale indoor areas or places with complex structures, the process of fingerprint data collection becomes even more cumbersome and time-consuming. In the related art, most of the fingerprint data is collected manually, so the process of collecting fingerprint data information consumes considerable time and costs.

Moreover, the accuracy of positioning results based on fingerprint data is related to a number of collection points. When there are less collection points, the positioning accuracy is poor; and when there are more collection points, the positioning accuracy improves accordingly. That is, the accuracy of fingerprint database positioning technology depends on a data volume in the fingerprint database. Therefore, in order to ensure the accuracy of positioning results, it is impossible to save time and resources required by the collection process of fingerprint data information by reducing the data volume.

In addition, as mentioned above, the data of a fingerprint database needs to be updated and maintained at regular intervals so as to adapt to changes in the indoor environment. The maintenance of data in the fingerprint database, such as introducing new collection points, deleting invalid or outdated data, and updating the signal characteristics of existing data, also requires continuous investment of resources and efforts to ensure the accuracy and reliability of the fingerprint database.

One or more of the above reasons may involve extensive data processing, which will increase the deployment time of fingerprint database positioning technology, thereby restricting the use and promotion of the fingerprint database technology.

In order to solve the above problems, the applicant conducted a study on datasets involved in some scenarios related to the fingerprint database positioning technology. The applicant discovered that the fingerprint data within a given region exhibits a certain degree of correlation, that is, many of the collected fingerprint data are actually similar or redundant. Therefore, the dense data collection may not be necessary. The correlation of fingerprint data is described below using a datasets from a 3GPP-defined indoor factory-dense high (InF-DH) scenario as an example.

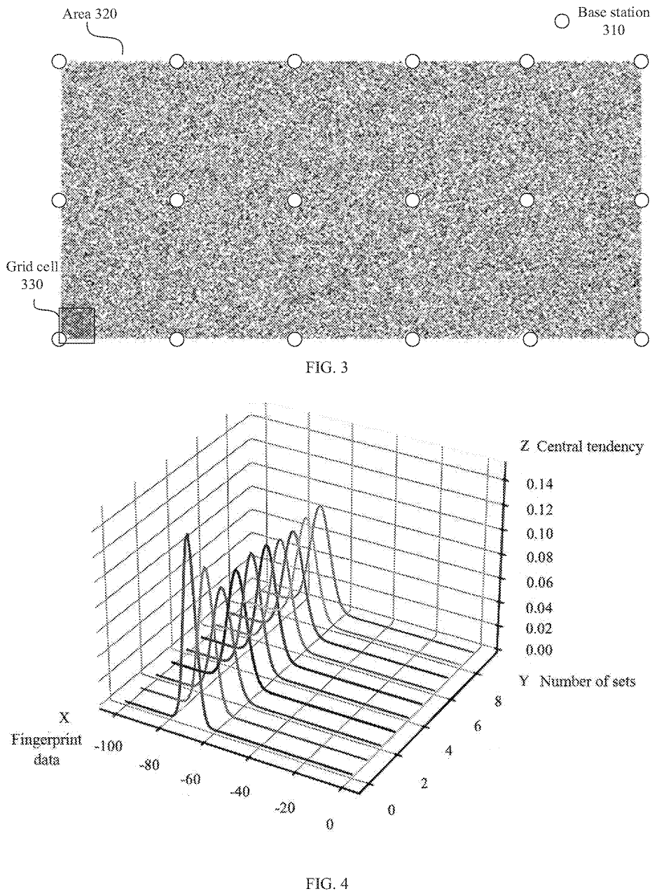

FIG. 3 is a schematic diagram showing fingerprint data locations in an indoor factory-dense high scenario. The InF-DH scenario features dense clutter (60%) and a relatively large number of base stations, and the scenario is defined as a highly NLOS scenario.

Referring to FIG. 3, the InF-DH scenario has a total of 18 base stations 310, which are evenly distributed in an indoor factory area 320 of a 120×60 m at intervals of Spacing D. FIG. 3 shows a total of 80,000 data locations, where each point in the indoor factory area 320 corresponds to one data location.

For ease of analysis, the indoor factory area 320 may be divided into a number of grid cells according to a given size, for example, according to side lengths (2 m×2 m). Taking a grid cell 330 as an example, each point within the grid cell 330 corresponds to one piece of fingerprint data, and therefore, the grid cell includes a total of 60 pieces of fingerprint data.

In order to observe the distribution differences across different data volumes, a number of sets of fingerprint data may be formed based on the fingerprint data in the grid cell 330. For example, a given proportion of data may be selected each time from among 60 pieces of fingerprint data of the grid cell 330 to generate a new set of fingerprint data. Taking the generation of 10 sets of fingerprint data as an example, 10%, 20%, 30%, . . . , and 100% of the total fingerprint data volume may be sequentially selected from among the fingerprint data of the grid cell 330. That is, each set of data represents a different proportion of the total data, and the data volume of each set of data increases gradually relative to the total data volume. The data in each set of data may be randomly selected from among the fingerprint data of the grid cell 330.

A Gaussian distribution curve of each set of data is shown in FIG. 4. Based on the Gaussian distribution of each set of data, information such as data distribution, central tendency, and dispersion of the set of data may be obtained. Referring to FIG. 4, the Gaussian distribution of each set of data corresponds to one curve in the figure. The center position of each curve corresponds to a mean of the corresponding set of data, and the width and shape of each curve correspond to a standard deviation of the corresponding set of data. A Y-axis represents numbers of the sets of data, an X-axis represents fingerprint data, and a Z-axis represents a central tendency of the data distribution.

As can be seen from FIG. 4, curves of the third set of data to the tenth set of data exhibit minimal differences, indicating that the distribution characteristics of the third set of data are similar to those of the fourth to tenth sets of data. That is, the distribution characteristics of the data with a data volume of 30% are nearly the same as those of the data with data volumes of 40%, 50%, . . . , and 100%.

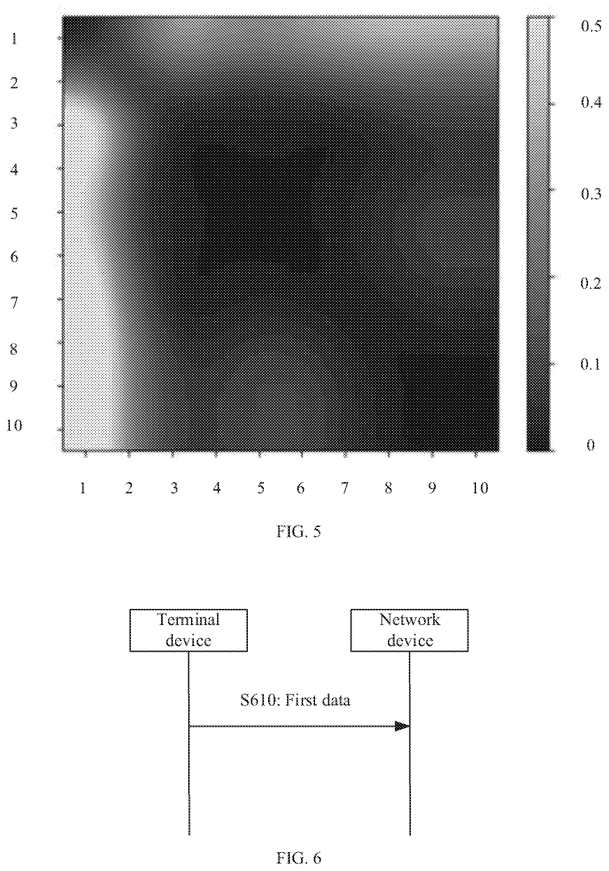

In addition, the dispersion information of each set of data is shown in FIG. 5, where different color shades correspond to different levels of dispersion. The lower the correlation among the data, the higher the dispersion; conversely, the higher the correlation among the data, the lower the dispersion. As can be seen from FIG. 5, the data within the grid cell 330 are concentrated in a lower right corner of FIG. 5, with the dispersion of less than 0.1.

Therefore, the applicant has found that the distribution of data within a given region, such as within a single grid cell, exhibits strong correlation. Based on this, some embodiments of the present disclosure provide a method for training a positioning model. Through the method, based on actually collected fingerprint data (that is, first data), some expanded fingerprint data (that is, second data) is acquired, and both the first data and the second data are used for training the positioning model. In this way, the amount of fingerprint data that needs to be collected during the establishment of fingerprint database may be reduced, thereby facilitating to reduce the time and resource consumption of establishing the fingerprint database.

FIG. 6 is a schematic flowchart illustrating a method for training a positioning model according to some embodiments of the present disclosure. The method shown in FIG. 6 may involve interaction between a network device and a terminal device. In some embodiments, the method shown in FIG. 6 may also involve data exchanges between a location server and the network device. The method for training the positioning model according to the embodiments of the present disclosure will be described in detail from the perspective of interaction between the network device and the terminal device.

As shown in FIG. 6, the method includes a step S610. In step S610, the terminal device sends first data to the network device, that is, the network device receives the first data transmitted by the terminal device.

The first data mentioned above may be the fingerprint data for positioning as described above. For example, the first data may include measurement results of a reference signal. As an example, the reference signal may be a received signal strength (RSS), such as a reference signal received power (RSRP). For another example, the first data may include position information, that is, information on the position where the first data is measured, such as position coordinates.

In some embodiments, the reference signal may be transmitted from the network device to the terminal device. For example, the reference signal may be transmitted from one or more network devices to the terminal device. That is, the collection process of the fingerprint data, that is, the first data, may involve the terminal device or and one or more network devices. In this case, the terminal device may collect data for each of the network devices separately, and transmit the collected first data to the corresponding network device.

In some embodiments, the first data may be used to determine the second data. For example, the second data may be determined based on the correlation among data, for example, based on distribution characteristics of the first data. The distribution characteristics of the first data may refer to, for example, a dispersion, a central tendency, and distribution locations of mean and standard deviation of the distribution of the first data. As an example, the distribution characteristics of the first data may include its conformity to a Gaussian distribution.

In some embodiments, the first data and the second data may be used as training data for a positioning model, which may be used to locate terminal devices in a target positioning area. For example, the positioning model may be used for indoor positioning based on a fingerprint database. The positioning model may be an artificial intelligence (AI) model. Alternatively, the positioning model may be a machine learning (ML) model.

By acquiring the second data based on the actually collected first data, training data used for the positioning model can be expanded, which helps to reduce an amount of fingerprint data that needs to be collected, thereby reducing the time and resource consumption for collecting a large amount of fingerprint data.

In some embodiments, the target positioning area may include a first grid cell, and the first data are measurement results of the reference signal acquired with the terminal device located in the first grid cell.

For example, the target positioning area may be divided into a plurality of grid cells, and the first grid cell may be any one of the plurality of grid cells. In this case, the terminal device may transmit the first data corresponding to different grid cells to the network device. Before transmitting the first data, the terminal device may acquire the first data in each grid cell, that is, the terminal device measures the reference signal in each grid cell.

As mentioned above, the first data follow a Gaussian distribution. Based on this, in some embodiments, an expression of a joint Gaussian distribution for the first grid cell may be determined based on a mean matrix and a standard deviation matrix. A detailed example will be described later (such as, the third operation described below), and will not be repeated herein.

It should be noted that the grid cell mentioned herein refers to a sub-area of the target positioning area. The first grid cell may also be referred to by other names, such as a first sub-area, which is not limited herein.

As mentioned above, the applicant discovered that fingerprint data in a given region exhibits a certain degree of correlation. Similarly, the fingerprint data in the first grid cell also exhibits correlation. Based on this, the second data corresponding to the first grid cell may be determined based on the distribution characteristics of the first data within the first grid cell.

In some embodiments, the second data may be obtained by performing random sampling in a distribution range of the first data. The distribution range of the first data may be determined based on the Gaussian distribution of the first data. As an example, the distribution range of the first data may include data corresponding to distribution probability values greater than zero. That is, the second data may be randomly selected from the data whose distribution probability values are greater than zero. In order to improve the validity of the second data, the second data may be randomly selected from data whose distribution probability values are greater than a first threshold. The first threshold may be determined based on usage requirements. For example, the first threshold may be 0.1.

In some embodiments, the second data may be obtained by performing sampling, in accordance with probability values, within a distribution range of the first data, thereby helping to improve the reliability of the expanded data. The probability values mentioned herein may refer to distribution probability values of data. That is, the second data may be sampled and obtained based on the probability values corresponding to the data within the distribution range of the first data. For example, the amount of the second data as sampled may be positively proportional to the probability values corresponding to data within the distribution range of the first data. That is, more data may be collected from data ranges with higher probabilities of occurrence (that is, higher probability values) as the second data, and less data may be collected from data ranges with lower probabilities of occurrence (that is, lower probability values) as the second data.

In order to further improve the reliability of the second data, the second data may be obtained based on the probability values from data having distribution probability values greater than a second threshold. The second threshold may be the same as or different from the first threshold.

In some embodiments, the distribution characteristics of the first data may be determined based on a Gaussian distribution curve, a probability density curve, or a probability distribution curve.

In the embodiments of the present disclosure, the second data is acquired based on the above mentioned correlation among data, such as distribution characteristics of the first data, which helps to reduce a difference between the second data and the actual fingerprint data, that is, helps to improve the accuracy of the second data. In this way, using both the first data and the second data as training data for the positioning model helps to reduce the amount of the fingerprint data that needs to be collected, while the positioning accuracy of the positioning model remains substantially unchanged.

Before collecting the fingerprint data in the target positioning area, it is necessary to determine the distribution characteristics of fingerprint data in the target positioning area, such as the distribution characteristics of the first data. In some embodiments, the distribution characteristics of the first data may be determined based on the distribution characteristics of data in the same or similar scenarios. For example, the distribution characteristics of the first data may be determined based on the distribution characteristics of third data. The third data may be the measurement results of reference signals in a reference area, and the reference area is of the same type as the target positioning area.

In some embodiments, the reference area and the target positioning area being of the same type may mean that the reference area and the target positioning area have a same environmental type. That is, the reference area of the target positioning area may be determined based on the environmental type. The environmental type may include, for example, a ratio of a direct path to a non-direct path, a ratio of a line-of-sight (LOS) area to a non-line-of-sight (NLOS) area, a scenario's architectural structure and internal layout, and the like. As an example, when the target positioning area is an area on a first floor of a shopping mall, and its reference area may be an area on a second floor of the shopping mall in a same building structure as the first floor of the shopping mall.

In some embodiments, the target positioning area may include a first grid area and a second grid area. When the environmental types of the first grid area and the second grid area are the same, the distribution characteristics of the fingerprint data in the first grid area may be determined based on the distribution characteristics of the fingerprint data (that is, the third data) in the second grid area.

In some embodiments, the amount of the first data may be determined based on the distribution characteristics of the third data. For example, when 30% of the data volume of the third data in the reference area has distribution characteristics similar to those of 100% of the data volume (as illustrated in FIG. 3 mentioned above), then the data volume of the first data may be 30% of the desired amount of fingerprint data. The desired amount of fingerprint data mentioned herein may refer to an amount of training data determined according to the positioning accuracy of the positioning model.

When a training process of the positioning model involves a plurality of network devices, the amount of the first data may be determined based on the distribution characteristics of the third data corresponding to each of the plurality of network devices. The distribution characteristics of the third data corresponding to each network device may be different, that is, an initial amount of the first data determined based on the third data corresponding to each of different network devices may vary.

In some embodiments, the amount of the first data may be determined based on the maximum of initial amounts of the first data. For example, 30% of the data volume of the third data corresponding to a first network device has distribution characteristics similar to those of 100% of the data volume, and correspondingly, a first initial amount of the first data may be 30% of the desired amount of fingerprint data. 40% of the data volume of the third data corresponding to a second network device has distribution characteristics similar to those of 100% of the data volume, and correspondingly, a second initial amount of the first data may be 40% of the desired amount of fingerprint data. The amount of the first data may be the maximum of the first initial amount and the second initial amount, that is, 40% of the desired amount of fingerprint data.

In some embodiments, the amount of the second data that needs to be sampled may be determined based on the amount of the first data and the desired amount of fingerprint data.

It should be noted that the second data includes expanded data based on the measurement results of the reference signal. However, the second data does not include the corresponding position information.

In some embodiments, the second data used as training data for the positioning model may be fully or partially labeled with position tags. The position tags of the second data mentioned herein may include, for example, position information corresponding to the second data. In the case where the second data fully labeled with position tags and the first data are used as the training data, the positioning model may be obtained based on a neural network. In the case where the second data partially labeled with position tags and the first data are used as the training data, the positioning model may be obtained using a semi-supervised learning method.

Since an area of a grid cell region is relatively small and the amount of change in the first data within the grid cell is also relatively small, the position tags corresponding to the second data may be position coordinates within the first grid cell that are randomly generated.

In some embodiments, output results of the positioning model may be the position coordinates and the position information about the first grid cell, or output results of the positioning model may be the position information about the first grid cell. A type of the output results of the positioning model may be determined based on positioning accuracy requirements. For scenarios with low positioning accuracy requirements, output results of the positioning model may be the position information about the grid cell. For scenarios with rigorous positioning accuracy requirements, output results of the positioning model may be specific position coordinates and the position information about the first grid cell.

In some embodiments, grid data (also referred to as a grid map) of the target positioning area may be updated based on data from a user end. The grid data mentioned herein may include grid position information and fingerprint database data corresponding to each grid. During a positioning process using the positioning model, when positioning results corresponding to the data from the user end, such as the measurement results of a reference signal, is the first grid cell, the measurement result of the reference signal may be used to update data of the first grid cell. For example, the measurement results of the reference signal may be used as fingerprint database data corresponding to the first grid cell. Further, the positioning model may be updated based on update results of the grid map, so as to improve the accuracy of the positioning model.

Since the grid map may occupy a large amount of storage resources, the aforementioned grid map may be, for example, stored in a location server.

The training process of the positioning model may involve a plurality of network devices, and the embodiments of the present disclosure do not limit the data collection sequence. In some embodiments, the first data corresponding to the plurality of network devices may be collected in one grid cell separately, followed by collecting the first data corresponding to the plurality of network devices in another grid cell separately. In other embodiments, the first data corresponding to one network device may be collected in each of a plurality of grid cells separately, followed by collecting the first data corresponding to another network device in each of the plurality of grid cells separately.

Since the process of training a model usually consumes a large amount of computational resources, to avoid affecting normal communication of the network devices, the training of the positioning model may be performed by the location server.

The location server may receive the first data and the second data transmitted from the network devices, that is, the network devices may transmit the first data and the second data to the location server. The second data is determined based on the first data, such as being determined based on the distribution characteristics of the first data. Both the first data and the second data serve as training data for the positioning model.

A method for training a positioning model according to an embodiment of the present disclosure will be described in detail blow in conjunction with a specific example.

In a first operation, a target positioning area is divided into a number of grid cells (including a first grid cell) each having side lengths of (x, y), where each grid cell represents a sub-area.

In a second operation, fingerprint data collection (that is, collection of the first data) is performed.

Before the fingerprint data collection is performed, a terminal device may establish a connection with a network device.

The fingerprint data collection is performed n times in the first grid cell to obtain n pieces of fingerprint data.

When a plurality of network devices are deployed in the target positioning area for positioning, n pieces of fingerprint data may be collected for one network device, and then the collection process proceeds with a next network device to repeat these operations until the fingerprint data corresponding to all of the network devices is collected. A fingerprint data matrix

$${H}_{data} = [ \begin{matrix}{data}_{1 , 1} & {data}_{2 , 1} & ⋯ & {data}_{i , 1} \\ {data}_{1 , 2} & {data}_{2 , 2} & ⋯ & {data}_{i , 2} \\ ⋮ & ⋮ & ⋮ & ⋮ \\ {data}_{1 , n} & {data}_{2 , n} & ⋯ & {data}_{i , n}\end{matrix} ] = [ \begin{matrix}{x}_{1} \\ {x}_{2} \\ ⋮ \\ {x}_{i}\end{matrix} ]$$

for the first grid cell is then obtained, where data denotes the fingerprint data, n denotes a data index, and i denotes a base station index.

In a third operation, distribution characteristics of the first data are determined.

In the fingerprint data matrix, the mean and standard deviation of data associated with a same base station are calculated to obtain a mean matrix

$$μ = {}_{mean} ( {H}_{data} ) = [ \begin{matrix}mean ( {x}_{1} ) \\ mean ( {x}_{2} ) \\ ⋮ \\ mean ( {x}_{i} )\end{matrix} ] = [ \begin{matrix}{μ}_{1} \\ {μ}_{2} \\ ⋮ \\ {μ}_{i}\end{matrix} ]$$

and a standard deviation matrix

$$σ = {}_{std} ( {H}_{data} ) = [ \begin{matrix}{}_{std} ( {x}_{1} ) \\ std ( {x}_{2} ) \\ ⋮ \\ std ( {x}_{i} )\end{matrix} ] = [ \begin{matrix}{σ}_{1} \\ {σ}_{2} \\ ⋮ \\ {σ}_{i}\end{matrix} ]$$

for the fingerprint data.

Further, based on the mean matrix and the standard deviation matrix, an expression of a joint Gaussian distribution for the grid cell is obtained:

$$f ( x ) = \frac{1}{{( \sqrt{2 π} )}^{d} ( {σ}_{1} , {σ}_{2} , ⋯ {σ}_{i} )} exp ( - \frac{1}{2} {d}^{2} ( x , μ ) ) ,$$

$$where$$

$${d}^{2} ( x , μ ) = {( \frac{{x}_{1} - {μ}_{1}}{{σ}_{1}} )}^{2} + {( \frac{{x}_{2} - {μ}_{2}}{{σ}_{2}} )}^{2} + ⋯ + {( \frac{{x}_{i} - {μ}_{i}}{{σ}_{i}} )}^{2} .$$

The joint Gaussian distribution mentioned herein may represent a Gaussian distribution of the fingerprint data of the first grid cell corresponding to all the network devices.

In a fourth operation, sampling is performed on each dimension of the joint Gaussian distribution obtained in the third operation to generate m pieces of expanded fingerprint data, that is, the second data. After the expansion, a size of the fingerprint data (that is, including the first data and the second data) is [i,m+n] where i denotes the base station index, and m+n denotes an amount of fingerprint data associated with a single base station, with n indicating that the collection of fingerprint data was performed n times so as to obtain n pieces of fingerprint data.

In some embodiments, random sampling on each dimension of the joint Gaussian distribution may be performed, or sampling may be performed based on the magnitude of probabilities, thereby obtaining the second data.

In a fifth operation, the above first to fourth operations are repeated for each grid cell to obtain the second data corresponding to all grid cells.

In a sixth operation, the second data and the first data are merged to obtain augmented fingerprint data.

In a seventh operation, position tags for the second data are generated.

Since each grid has a very small area and variation of signals within the grid is also very small, coordinates randomly generated within the grid may be used as the position tags for the second data.

In some embodiments, the first data and the second data having the position tags may be inputted into a neural network for training to obtain the positioning model.

In other embodiments, a portion of the second data that has the tags, a large portion of the second data that has no tags, and the first data are simultaneously inputted into an artificial intelligence mode, to obtain the positioning model in a semi-supervised learning method.

In some embodiments, the network device may receive measurement results of a reference signal reported from the user end and forward the measurement results to the location server. The location server may predict, based on the above positioning model internally deployed, the user's position and/or position information of the grid where the user is located. At the same time, the location server may transmit the user's position and/or position information of the grid where the user is located to the user through the network device.

In some embodiments, the location server includes grid distribution information of the target positioning area, such as sizes and position information of the grids in the target positioning area.

The method according to embodiments of the present disclosure can reduce the workload to collect a large amount of fingerprint data in the target positioning area, thereby improving the efficiency of the positioning method. In addition, the method according to embodiments of the present disclosure utilizes principles of correlation between fingerprint data, to expand the amount of fingerprint data by performing random sampling on the joint Gaussian distribution of the data, which helps to reduce the time consumed by fingerprint data collection.

Moreover, the method according to the embodiments of the present disclosure can greatly reduce the workload of fingerprint data collection while keeping the positioning accuracy substantially unchanged. For example, the method according to the embodiments of the present disclosure can reduce the amount of fingerprint data collection in the fingerprinting data collection process to ⅓ of the original amount, thereby greatly reducing the consumption of time, labor, and material resources. Since the method according to the embodiments of the present disclosure does not require the installation of additional hardware devices, nor does it requires the upgrading and transformation of existing hardware devices, it is simple to implement and thus has certain advantages and promotion prospects in high-precision indoor positioning application scenarios.

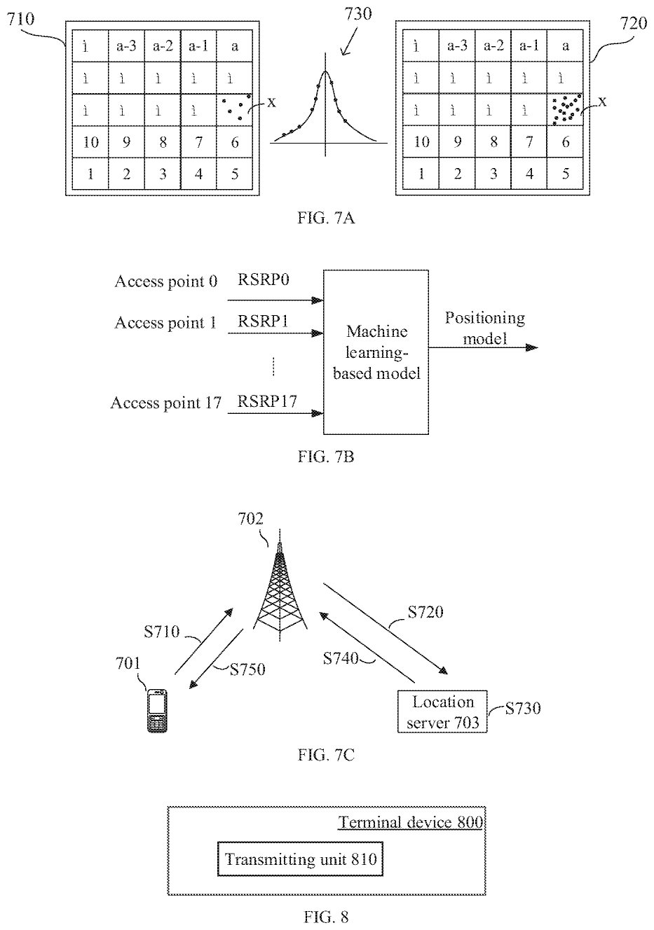

A method for training and using a positioning model according to some embodiments of the present disclosure is described below with reference to FIG. 7A to FIG. 7C.

FIG. 7A is an example diagram of obtaining augmented fingerprint data according to some embodiments of the present disclosure. Referring to FIG. 7A, a grid map 710 is a grip map corresponding to fingerprint data actually collected (that is, the first data), and a grid map 720 is a grip map corresponding to augmented fingerprint data (including the first data and the second data), where a denotes a grid index. Taking Grid x as an example, in the grid map 710, the points within Grid x represent the first data; in grid map 720, the points within Grid x represent merged results of the first data and the second data. The second data is obtained based on the distribution characteristics of the first data. Principles of obtaining the second data is illustrated by a reference sign 730 in FIG. 7A.

FIG. 7B is an example diagram of training a positioning model according to some embodiments of the present disclosure. In FIG. 7B, a machine learning-based model is trained with fingerprint data. The first data corresponding to a plurality of network devices (such as RSRP measurement results corresponding to Access Points 0 to 17) are the input to the model, and the output is the positioning model. The positioning model may be trained based on a centralized unit.

The devices involved in the positioning process are related to a deployment location of the positioning model. In some embodiments, the positioning model may be deployed on one or more network devices. In other embodiments, the positioning model may be deployed on a location server, thereby helping to save computational resources of the network devices. The positioning process is described below by taking the deployment of the positioning model on the location server as an example.

FIG. 7C is a flowchart of a method for using a positioning model according to some embodiments of the present disclosure. The method shown in FIG. 7C includes steps S710 to S750. The method shown in FIG. 7C involves interaction among a terminal device 701, a network device 702, and a location server 703.

In step S710, the network device may receive measurement results of a reference signal that are transmitted from the terminal device. In other words, the terminal device may transmit the measurement results of the reference signal to the network device. The reference signal may be transmitted by the network device.

In step S720, the network device may send the received measurement results to the location server. In other words, the location server receives the measurement results sent by the network device.

In step S730, the location server generates positioning results.

The location server may input the measurement results into the positioning model, which then outputs the positioning results. The positioning results may be position coordinates and/or position information of the grid where the terminal device is located.

In step S740, the location server sends the positioning results to the network device.

In step S750, the network device transmits the positioning results to the terminal device.

In some embodiments, the method illustrated in FIG. 7C may further include a step S760 (not shown in the figure). In step S760, the location server may update, based on the positioning results, a grid map, that is, the grid data of the target positioning area. Further, the location server may update the positioning model based on the updated grid map.

By obtaining augmented fingerprint data (that is, the first data and the second data) based on the actually collected fingerprint data (that is, the first data), and training the positioning model based on the augmented fingerprint data, an amount of fingerprint data that needs to be collected can be reduced, which helps to reduce the time and resource consumption for establishing the fingerprint database and reduce the deployment time of fingerprint database positioning technology.

The method embodiments of the present disclosure are described in detail above, and device embodiments of the present disclosure will be described in detail below. It should be understood that the description of the method embodiments corresponds to the device embodiments, and therefore, the parts not described in detail herein may be referred to the preceding method embodiments.

FIG. 8 is a schematic structural diagram of a terminal device according to some embodiments of the present disclosure. A terminal device 800 includes a transmitting unit 810.

The transmitting unit 810 may be used to transmit first data to a network device. The first data is used to determine second data, the first data and the second data are used as training data for a positioning model, and the positioning model is used to locate the terminal device within a target positioning area. The target positioning area includes a first grid cell, and the first data are measurement results of a reference signal that are obtained by the terminal device when it is located in the first grid cell.

In some embodiments, the second data is obtained by performing random sampling within a distribution range of the first data, and/or the second data is obtained by performing sampling, in accordance with probability values, within the distribution range of the first data.

In some embodiments, distribution characteristics of the first data are determined based on distribution characteristics of third data, the third data are measurement results of a reference signal in a reference area, and the reference area is of a same type as the target positioning area.

In some embodiments, an amount of the first data is determined based on the distribution characteristics of the third data.

In some embodiments, part or all of the second data include position tags.

In some embodiments, the position tags corresponding to the second data are position coordinates that are randomly generated within the first grid cell.

In some embodiments, output results of the positioning model include position coordinates and position information of the first grid cell, or output results of the positioning model include position information of the first grid cell.

In some embodiments, distribution characteristics of the first data include its conformity to a Gaussian distribution, and an expression of a joint Gaussian distribution of the first grid cell is determined based on a mean matrix and a standard deviation matrix.

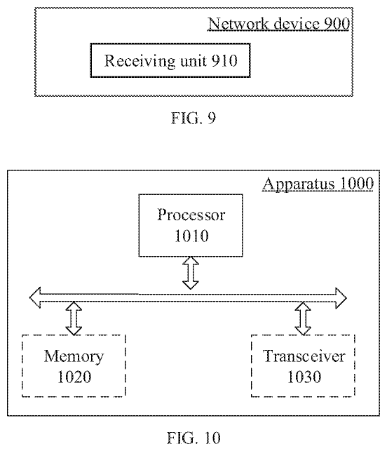

FIG. 9 is a schematic structural diagram of a network device according to some embodiments of the present disclosure. A network device 900 may include a receiving unit 910.

The receiving unit 910 is used to receive first data transmitted by a terminal device. The first data is used to determine the second data, the first data and the second data are used as training data for a positioning model, and the positioning model is used to locate the terminal device in a target positioning area. The target positioning area includes a first grid cell, and the first data are measurement results of a reference signal that are obtained by the terminal device when it is located in the first grid cell.

In some embodiments, the second data is obtained by performing random sampling within a distribution range of the first data, and/or the second data is obtained by performing sampling, in accordance with probability values, within the distribution range of the first data.

In some embodiments, distribution characteristics of the first data are determined based on distribution characteristics of third data, the third data are measurement results of a reference signal in a reference area, and the reference area is of a same type as the target positioning area.

In some embodiments, an amount of the first data is determined based on the distribution characteristics of the third data.

In some embodiments, part or all of the second data include position tags.

In some embodiments, the position tags corresponding to the second data are position coordinates that are randomly generated within the first grid cell.

In some embodiments, output results of the positioning model include position coordinates and position information of the first grid cell, and/or output results of the positioning model include position information of the first grid cell.

In some embodiments, distribution characteristics of the first data include its conformity to a Gaussian distribution, and an expression of a joint Gaussian distribution of the first grid cell is determined based on a mean matrix and a standard deviation matrix.

In optional embodiments, the transmitting unit 810 and the receiving unit 910 may be implemented as a transceiver 1030. The terminal device 800 or the network device 900 may further include a processor 1010 and/or a memory 1020, as illustrated in FIG. 10.

FIG. 10 is a schematic structural diagram of an apparatus according to some embodiments of the present disclosure. An apparatus 1000 may be a device for training a positioning model or a device configured for positioning. Dashed lines in FIG. 10 indicate that the unit or module is optional. The apparatus 1000 may be configured to perform the methods described in the above method embodiments. The apparatus 1000 may be an electronic device, a chip, a terminal device or a network device.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (CPU). Alternatively, the processor may also be other general-purpose processor, a digital signal processor (DSP), an application-specific integrated circuit (ASIC), a field-programmable gate arrays (FPGA), or another programmable logic device, a discrete gate or transistor logic device, a discrete hardware component and the like. The general-purpose processor may be a microprocessor, or any conventional processor.

The apparatus 1000 may further include one or more memories 1020. The memory 1020 stores programs thereon, which can be executed by the processor 1010, to cause the processor 1010 to perform the methods described in the foregoing method embodiments. The memory 1020 may be separate from the processor 1010 or may be integrated in the processor 1010.

The apparatus 1000 may further include a transceiver 1030. The processor 1010 may communicate with other devices or chips via the transceiver 1030. For example, the processor 1010 may transmit and receive data with other devices or chips via the transceiver 1030.

An embodiment of the present disclosure further provides a computer-readable storage medium storing a program. The computer-readable storage medium may be applied to the terminal device or the network device according to embodiments of the present disclosure, and the program stored therein causes a computer to perform the methods executed by the terminal device or the network device in each embodiment of the present disclosure.

An embodiment of the present disclosure further provides a computer program product. The computer program product includes a program. The computer program product may be applied to the terminal device or the network device according to embodiments of the present disclosure, and the program causes a computer to perform the methods executed by the terminal device or the network device in each embodiment of the present disclosure.

An embodiment of the present disclosure further provides a computer program. The computer program may be applied to the terminal device or the network device according to embodiments of the present disclosure, and the computer program causes a computer to perform the methods executed by the terminal device or the network device in each embodiment of the present disclosure.

It should be understood that the terms “system” and “network” used in the present disclosure may be used interchangeably. In addition, the terms used in the present disclosure are intended only to explain specific embodiments of the present disclosure, and are not intended to limit the present disclosure. The terms “first,” “second,” “third,” and “fourth,” etc., as used in the description, claims, and drawings of the present disclosure are used to distinguish different objects, rather than to describe a particular order. In addition, the terms “include/comprise” and “have” and any variations thereof are intended to cover non-exclusive inclusion.

In the embodiments of the present disclosure, the term “indicate” may refer to a direct indication, or an indirect indication, or a relationship of association. For example, “A indicates B” may mean that A directly indicates B, for example, B may be obtained through A; it may also mean that A indirectly indicates B, for example, A indicates C, and B may be obtained through C; or it may simply denote that A and B have an associated relationship therebetween.

In the embodiments of the present disclosure, “B corresponding to A” means that B is associated with A, and B may be determined according to A. However, it should also be understood that determining B according to A does not necessarily mean that B is determined solely based on A, and B may also be determined according to A and/or other information.

In the embodiments of the present disclosure, the term “corresponding” may refer to a direct or indirect correspondence between the two, an associated relationship between the two, or relationships such as indication/being indicated, and configuration/being configured.

In the embodiments of the present disclosure, the terms “pre-defined” or “pre-configured” may be implemented by pre-storing corresponding codes, tables, or other means used to indicate relevant information in the device (for example, including a terminal device and a network device), and the present disclosure places no limitations on the specific implementation. For example, “predefined” may refer to definitions provided in a protocol.

In the embodiments of the present disclosure, the term “protocol” may refer to standard protocols in the field of communications, including but not limited to LTE protocol, NR protocol, or other related protocols applied in future communication systems, which will not be limited herein.

In the embodiments of the present disclosure, the term “and/or” represents merely an association relationship describing associated objects, indicating that there may be three types of relationships. For example, A and/or B may mean three types of situation, that is, the existence of A alone, the existence of both A and B, and the existence of B alone. In addition, the character “/” herein generally indicates that the associated objects are in an “or” relationship.

In the embodiments of the present disclosure, the term “include” may refer to either direct inclusion or indirect inclusion. Optionally, the term “include” in the embodiments of the present disclosure may be replaced with “indicate” or “be used to determine.” For example, “A including B” may be replaced with “A indicating B” or “A being used to determine B.”

In various embodiments of the present disclosure, the numerical order of various processes above does not necessarily indicate an execution order. The execution order should be determined based on the functions and inherent logic of the various processes, and should not be construed as any limitation on the implementation process of the embodiments of the present disclosure.

In some embodiments of the present disclosure, it should be understood that the disclosed systems, devices, and methods may be implemented in other ways. For example, the described device embodiments are merely illustrative. For example, the division of units is only one logical functional division, and other manners of division may be adopted in actual implementation; for example, a plurality of units or components may be combined or integrated into another system, or some features may be omitted or not executed. In addition, mutual couplings, direct couplings, or communication connections illustrated or discussed may be indirect couplings or communication connections by means of some interfaces, devices, or units, and the couplings or connections may be electrical, mechanical, or of other forms.

The units described as separate components may or may not be physically separated, and a component illustrated as a unit may or may not be a physical unit, that is, the component may be located at one site, or distributed on a plurality of network units. Part or all of the units may be selected according to actual requirements to achieve the objective of the solution of the embodiments.

In addition, the functional units in each embodiment of the present disclosure may be integrated into one processing unit, may exist separately as individual physical units, or two or more units may be integrated into one unit.

The above embodiment can be fully or partially implemented using software, hardware, firmware, or any combination thereof. When implemented using software, it can be fully or partially implemented in the form of a computer program product. The computer program product includes one or more computer instructions. When the computer instructions are loaded and executed on a computer, the processes or functions described in the embodiments of the present disclosure are partially or wholly generated. The computer may be a general-purpose computer, a special-purpose computer, a computer network, or other programmable devices. The computer instructions may be stored in a computer-readable storage medium, or may be transmitted from one computer-readable storage medium to another computer-readable storage medium. For example, the computer instructions may be transmitted from one website, computer, server, or data center to another website, computer, server, or data center via a wired (such as coaxial cable, optical fiber, digital subscriber line (DSL)) or wireless (such as infrared, radio, microwave) manner. The computer-readable storage medium may be any available medium that can be read by a computer or a data storage device such as a data center or a server that is integrated with one or more available media. The available media may be a magnetic medium (such as a floppy disk, a hard disk, a magnetic tape), an optical medium (such as a digital video disc (DVD)), or a semiconductor medium (such as a solid-state drive (SSD)), etc.

The above are only specific embodiments of the present disclosure, and the protection scope of the application is not limited thereto. Any modifications or substitutions that can be readily conceived by those skilled in the art within the technical scope disclosed in the present disclosure should be covered within the protection scope of the present disclosure. Therefore, the protection scope of the present disclosure shall be subject to the protection scope defined in the claims.

What is claimed is:

1. A method for training a positioning model, comprising:
transmitting, by a terminal device, first data to a network device; wherein the first data is used to determine second data, the first data and the second data are used as training data for a positioning model, and the positioning model is used to locate the terminal device in a target positioning area; wherein
the target positioning area comprises a first grid cell, and the first data are measurement results of a reference signal, wherein the measurement results of the reference signal are obtained by the terminal device when the terminal device is located in the first grid cell.

2. The method of claim 1, wherein the second data is obtained by performing random sampling within a distribution range of the first data, and/or the second data is obtained by performing sampling, in accordance with probability values, within the distribution range of the first data.

3. The method of claim 1, wherein distribution characteristics of the first data are determined based on distribution characteristics of third data, the third data are measurement results of a reference signal in a reference area, and the reference area is of a same type as the target positioning area.

4. The method of claim 3, wherein an amount of the first data is determined based on the distribution characteristics of the third data.

5. The method of claim 1, wherein part or all of the second data comprise position tags.

6. The method of claim 5, wherein the position tags corresponding to the second data are position coordinates randomly generated within the first grid cell.

7. The method of claim 1, wherein output results of the positioning model comprise position coordinates and position information of the first grid cell, or output results of the positioning model comprise position information of the first grid cell.

8. The method of claim 1, wherein distribution characteristics of the first data comprise conformity to a Gaussian distribution, and an expression of a joint Gaussian distribution of the first grid cell is determined based on a mean matrix and a standard deviation matrix.

9. A method for training a positioning model, comprising:
receiving, by a network device, first data transmitted by a terminal device; wherein the first data is used to determine second data, the first data and the second data are used as training data for a positioning model, and the positioning model is used to locate the terminal device in a target positioning area; wherein
the target positioning area comprises a first grid cell, and the first data are measurement results of a reference signal, wherein the measurement results of the reference signal are obtained by the terminal device when the terminal device is located in the first grid cell.

10. The method of claim 9, wherein the second data is obtained by performing random sampling within a distribution range of the first data, and/or the second data is obtained by performing sampling, in accordance with probability values, within the distribution range of the first data.

11. The method of claim 9, wherein distribution characteristics of the first data are determined based on distribution characteristics of third data, the third data are measurement results of a reference signal in a reference area, and the reference area is of a same type as the target positioning area.

12. The method of claim 11, wherein an amount of the first data is determined based on the distribution characteristics of the third data.

13. The method of claim 9, wherein part or all of the second data comprise position tags.

14. The method of claim 13, wherein the position tags corresponding to the second data are position coordinates randomly generated within the first grid cell.

15. The method of claim 9, wherein output results of the positioning model comprise position coordinates and position information of the first grid cell, or output results of the positioning model comprise position information of the first grid cell.

16. The method of claim 9, wherein the distribution characteristics of the first data comprise conformity to a Gaussian distribution, and an expression of a joint Gaussian distribution of the first grid cell is determined based on a mean matrix and a standard deviation matrix.

17. A terminal device, comprising a memory storing a program and a processor, wherein the processor is configured to call the program in the memory to cause the terminal device to perform:
transmitting first data to a network device; wherein the first data is used to determine second data, the first data and the second data are used as training data for a positioning model, and the positioning model is used to locate the terminal device in a target positioning area; wherein
the target positioning area comprises a first grid cell, and the first data are measurement results of a reference signal, wherein the measurement results of the reference signal are obtained by the terminal device when the terminal device is located in the first grid cell.

18. The terminal device of claim 17, wherein the second data is obtained by performing random sampling within a distribution range of the first data, and/or the second data is obtained by performing sampling, in accordance with probability values, within the distribution range of the first data.

19. A network device, comprising a memory storing a program and a processor, wherein the processor is configured to call the program in the memory to cause the network device to perform the method of claim 9.

20. The network device of claim 19, wherein the second data is obtained by performing random sampling within a distribution range of the first data, and/or the second data is obtained by performing sampling, in accordance with probability values, within the distribution range of the first data.
